(19) United States
(12) Patent Application Publication
(10) Pub. No.: US 2026/0127138 A1
(43) Pub. Date: May 7, 2026

(54) FINE-GRAINED FILE SYSTEM AND FILE READING AND WRITING METHOD

(71) Applicant: ShanghaiTech University, Shanghai (CN)

(72) Inventors: Shu YIN, Shanghai (CN); Yanjie SONG, Shanghai (CN); Guancheng LI, Shanghai (CN)

(73) Assignee: ShanghaiTech University, Shanghai (CN)

(21) Appl. No.: 18/702,793

(22) PCT Filed: Mar. 31, 2023
(86) PCT No.: PCT/CN2023/085386

§ 371 Date: Apr. 18, 2024

(30) Foreign Application Priority Data
Mar. 28, 2023 (CN) 2023103183855

(51) Int. Cl. G06F 16/13; G06F 16/17

(52) U.S. Cl. CPC G06F 16/13; G06F 16/1727

(57) ABSTRACT

A fine-grained file system and a file reading and writing method are provided. When one or more first files require subfile reading or writing, a corresponding reading or writing operation is performed on subfiles of each first file by utilizing a double-layer index structure of this first file, implementing concurrent reading and writing functionality for large individual files, resulting in faster speeds and improved efficiency for file reading and writing.

### FIELD OF THE INVENTION

The present disclosure relates to the field of file systems, and in particular, to a fine-grained file system and a file reading and writing method.

### BACKGROUND OF THE INVENTION

Emerging non-volatile memory technologies come with impressive features such as low latency and high read-write bandwidth, making them well-suited for use as storage devices in existing data centers. These new hardware devices significantly boost the performance of storage subsystems, providing users with an improved experience.

However, when considering the use of these novel non-volatile memory devices as storage, proper file system support becomes crucial. Unfortunately, existing file systems have not been specifically optimized for these new non-volatile devices. While current non-volatile memory file systems focus on optimizing overall bandwidth, read-write latency, and multi-core scalability for multi-file operations, there remains an unmet need. Specifically, in scenarios like scientific computing, artificial intelligence (AI) training, and sensor data collection, effective optimization strategies for concurrent read-write operations on large individual files are required. Therefore, while existing non-volatile memory file systems address certain aspects, there is still room for efficient solutions tailored specifically to concurrent read-write scenarios involving large individual files.

### SUMMARY OF THE INVENTION

In view of the above-mentioned shortcomings, the present disclosure aims to provide a fine-grained file system and a file reading and writing method, which solve the problems in the related technology, specifically the inability to support concurrent read-write operations on large individual files and the lack of specialized optimization for non-volatile memory devices within traditional file systems.

The present disclosure provides a fine-grained file system, including an index structure setting module, configured to set, for each file, a double-layer index structure associated with subfiles in the file, and store the double-layer index structure in both a non-volatile memory device and a dynamic random access memory; and a file reading and writing module, connected to the index structure setting module, wherein when one or more first files require subfile reading or writing, the file reading and writing module is configured to, for each of the first files, locate a corresponding first subfile based on the double-layer index structure of this first file, and load data in a data block storing the first subfile into the dynamic random access memory, so as to perform a reading or writing operation on the first subfile.

In some embodiments of the present disclosure, the double-layer index structure of each file is configured by: establishing a first mapping relationship between an inode constructed for this file and sub-inodes respectively constructed for the subfiles in the file, so as to obtain a first layer index structure; establishing a second mapping relationship between the sub-inodes mapped to the inode and data blocks storing the subfiles corresponding to the sub-inodes, so as to obtain a second layer index structure; combining the first layer index structure and the second layer index structure to obtain the double-layer index structure.

In some embodiments of the present disclosure, the inode includes a key-value mapping table. The key-value mapping table includes one or more subfile numbers and one or more sub-inodes, with each of the subfile numbers corresponding one-to-one with one of the sub-inodes. The fine-grained file system obtains, based on subfile numbers of the first subfiles, sub-inodes that respectively correspond to the subfile numbers of the first subfiles.

In some embodiments of the present disclosure, for each subfile, its sub-inode includes a first pointer pair. The first pointer pair is configured to determine a location of a file log of the subfile, so as to update information of the file log after a writing operation on the subfile is completed.

In some embodiments of the present disclosure, the file log includes a second pointer pair. The second pointer pair is configured to obtain a physical address of the subfile when undergoing a reading or writing operation, and update the physical address. The second pointer pair is further configured to collect a file garbage after the physical address is updated.

In some embodiments of the present disclosure, the sub-inode includes a lock. The lock is configured to lock the subfile when a reading operation is performed on the subfile, and unlock the subfile when the reading operation is completed.

In some embodiments of the present disclosure, the fine-grained file system further includes a free list associated with a plurality of data blocks for file management. The fine-grained file system creates a new file when the plurality of data blocks managed by the free list are not fully utilized.

To achieve the above and other related purposes, the present disclosure provides a file reading and writing method, including: configuring, for each file, a double-layer index structure associated with subfiles in the file through a fine-grained file system; when one or more first files require subfile reading or writing, for each of the first files, locating a corresponding first subfile based on the double-layer index structure of this first file through the fine-grained file system, and performing a reading or writing operation on the first subfile.

As described above, the fine-grained file system and the file reading and writing method of the present disclosure have the following beneficial effects: when one or more first files require subfile reading or writing, a corresponding reading or writing operation is performed on subfiles of each first file by utilizing a double-layer index structure of this first file, implementing concurrent reading and writing functionality for large individual files, resulting in faster speeds and improved efficiency for file reading and writing.

### BRIEF DESCRIPTION OF DRAWINGS

FIG. 1 shows a schematic structural diagram of a fine-grained file system according to an embodiment of the present disclosure.

FIG. 2 shows a schematic diagram of a double-layer index structure according to an embodiment of the present disclosure.

FIG. 3 shows a schematic diagram of a key-value mapping table according to an embodiment of the present disclosure.

FIG. 4 shows a schematic diagram of first and second pointer pairs according to an embodiment of the present disclosure.

FIG. 5 shows a schematic diagram of a double-layer index structure with a lock according to an embodiment of the present disclosure.

FIG. 6 shows a flowchart of a file reading and writing method according to an embodiment of the present disclosure.

### DETAILED DESCRIPTION OF THE INVENTION

The embodiments of the present disclosure will be described below. Those skilled can easily understand other advantages and effects of the present disclosure according to contents disclosed by the specification. The present disclosure can also be implemented or applied through other different specific embodiments. Various modifications or changes can also be made to all details in the specification based on different points of view and applications without departing from the spirit of the present disclosure. It should be noted that the following embodiments and features of the following embodiments can be combined with each other if no conflict will result.

In the following description, referring to the accompanying drawings, which describe several embodiments of the present disclosure. It should be understood that other embodiments may be used and that changes in mechanical composition, structure, electrical, and operation may be made without departing from the scope of the present disclosure. The following detailed description should not be considered limiting, and the scope of the embodiments of the present disclosure is limited only by the claims of the patents. The terms used herein are for describing particular embodiments only, and are not intended to limit the present disclosure. Spatially related terms, such as “upper”, “lower”, “left”, “right”, “downward”, “below”, “bottom”, “above”, “top”, etc., can be used in the text for ease of explanation of the relationship between one element or feature and another element or feature shown in the figure.

In the present disclosure, unless otherwise expressly specified, terms such as “installation”, “connection”, “coupling”, “fixing”, and “holding” should be broadly understood. For example, when one element is referred to as being “connected to” another element, one element may be fixedly connected to or detachably connected to another element, may be mechanically connected to or electrically connected to another element, may be directly connected to another element, or may be indirectly connected to another element with another element interposed therebetween. These two elements may also communicate with each other internally. Those of ordinary skill in the art can understand the specific meanings of the above terms in the present disclosure according to specific situations.

Furthermore, as used herein, the singular forms “one”, “a/an” and “the” are intended to include the plural form, unless the context indicates otherwise. The terms “first”, “second”, “third”, “fourth”, etc., as used in the specification and claims of the present application, serve to distinguish similar objects without necessarily implying a specific order or sequence. It should be understood that such usage allows for interchangeability where appropriate, enabling the implementation of embodiments described here in an order other than that explicitly depicted or described. Moreover, the terms “include” and “comprise” indicate the existence of the described features, steps, operations, elements, components, items, categories, and/or groups, but do not exclude the existence, presence, or addition of one or more other features, steps, operations, elements, components, items, categories, and/or groups. It should be further understood that the terms “or” and “and/or” are inclusive, and are used to include any of the associated listed items and all combinations thereof. Therefore, “A, B or C” or “A, B and/or C” means “any of the following: A; B; C; A and B; A and C; B and C; A, B and C”. Exceptions to this definition apply only when combinations of elements, functions or operations are inherently paradoxical in some way.

In order to make the inventive purpose, technical solutions and beneficial technical effects of the present disclosure clearer, the present disclosure is described in further detail below through the following embodiments in conjunction with the accompanying drawings. It should be noted that the specific embodiments described herein are only illustrative, and are not intended to limit the present disclosure.

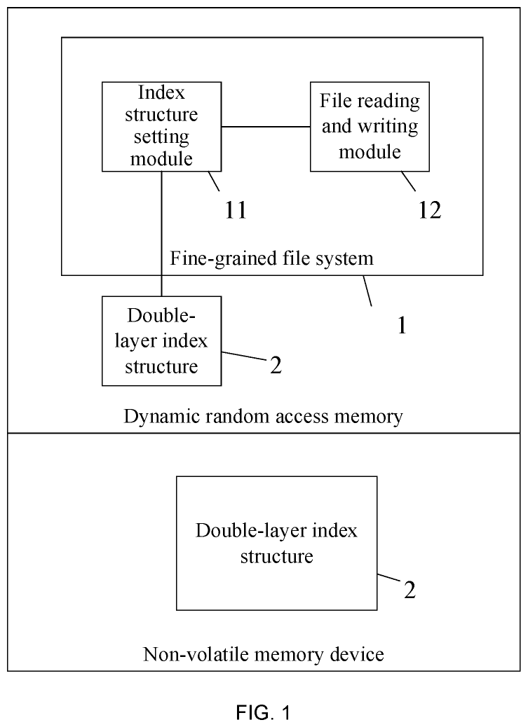

FIG. 1 shows a schematic structural diagram of a fine-grained file system 1 according to an embodiment of the present disclosure.

The fine-grained file system includes an index structure setting module 11 and a file reading and writing module 12.

The index structure setting module 11 is configured to set, for each file, a double-layer index structure 2 associated with subfiles in the file, and store the double-layer index structure 2 in both a non-volatile memory device and a dynamic random access memory. Specifically, the index structure setting module 11 divides each file into a plurality of subfiles based on a preset allocation granularity, and sets a double-layer index structure corresponding to this file. A mapping relationship between this file and its subfiles is constructed through the double-layer index structure.

It should be noted that the size of the preset allocation granularity may be selected according to actual requirements, which is not limited in the present disclosure, and the fine-grained file system must be loaded on the dynamic random access memory to implement file access.

The file reading and writing module 12 is connected to the index structure setting module 11. When one or more first files require subfile reading or writing, the file reading and writing module is configured to, for each of the first files, locate a corresponding first subfile based on the double-layer index structure of this first file, and load data in a data block storing the first subfile into the dynamic random access memory, so as to perform a reading or writing operation on the first subfile.

Data of the first file is stored in one or more data blocks, and each of the first subfiles of the first file corresponds to one of the data blocks for data storing.

Specifically, the reading or writing operation includes the following manners.

In a first manner, when one or more first files require subfile reading, the file reading and writing module 12 is configured to, for each of the first files, locate a data block corresponding to one of the first subfiles of the first file through the double-layer index structure of this first file, and load data in the data block into the dynamic random access memory, so as to perform a reading operation on the first subfile.

In a second manner, when one or more first files require subfile writing, the file reading and writing module 12 is configured to, for each of the first files, locate a data block corresponding to one of the first subfiles of the first file through the double-layer index structure of this first file, and load data in the data block into the dynamic random access memory, so as to perform a writing operation on the first subfile.

In a third manner, when one first file has first subfiles that need to be read as well as first subfiles where writing operations are needed, the file reading and writing module 12 is configured to, locate a first data block corresponding to one of the first subfiles that need to be read and a second data block corresponding to one of the first subfiles where writing operations are needed through the double-layer index structure of this first file, and load both a first data in the first data block and a second data in the second data block into the dynamic random access memory, so as to perform a reading operation on the first subfile that needs to be read and perform a writing operation on the first subfile where writing operations are needed.

It should be noted that the division of modules of the above device is only a logical function division, and the modules can be fully or partially integrated into a physical entity or physically separated in the actual implementation. In one embodiment, these modules can all be implemented in the form of software called by processing components. In one embodiment, they can also be all implemented in the form of hardware. In one embodiment, some of the modules can also be realized in the form of software called by processing components, and some of the module can be realized in the form of hardware.

In some preferred embodiments of the present disclosure, the index structure setting module 11 divides each file into a plurality of subfiles based on a size of a kernel page of a Linux operating system, that is, the preset allocation granularity is set as 4 KiB or 2 MiB. The index structure setting module 11 preferentially uses data blocks with 2 MiB allocation granularity to store subfile data, solving the problem of space fragmentation of the storage device.

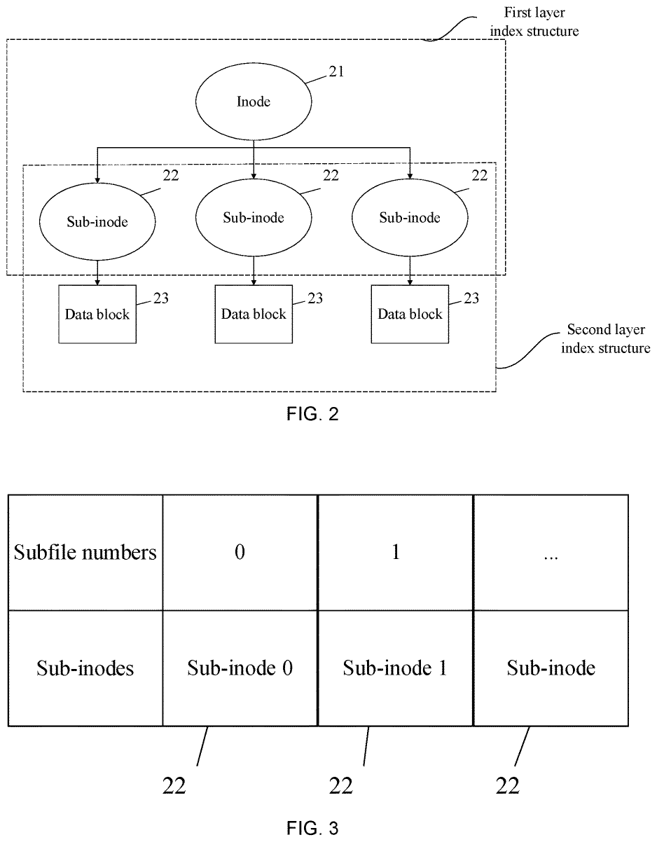

In some embodiments of the present disclosure, as shown in FIG. 2, the double-layer index structure of each file is configured by: establishing a first mapping relationship between an inode 21 constructed for this file and sub-inodes 22 respectively constructed for the subfiles in the file, so as to obtain a first layer index structure; establishing a second mapping relationship between the sub-inodes mapped to the inode 21 and data blocks storing the subfiles corresponding to the sub-inodes 22, so as to obtain a second layer index structure; combining the first layer index structure and the second layer index structure to obtain the double-layer index structure.

Specifically, the fine-grained file system configures each file with a corresponding inode 21. A plurality of inodes 21 constitutes an inode table. In addition, the fine-grained file system configures each of subfiles of this file with a corresponding sub-inode 22. In the first layer index structure, the inode 21 of the file is mapped one-to-many with sub-inodes 22 of the subfiles of the file. In the second layer index structure, the sub-inodes 22 mapped to the inode 21 are mapped one-to-one with data blocks storing the subfiles corresponding to the sub-inodes 22.

In some embodiments of the present disclosure, the reading or writing operation includes the following manners.

In a first manner, when one or more first files require subfile reading, the file reading and writing module is configured to, for each of the first files, first locate a sub-inode 22 of one of the first subfiles of the first file through the double-layer index structure 2 of this first file, then locate a data block 23 storing date of the first subfile, and finally load the data in the data block 23 into the dynamic random access memory, so as to perform a reading operation on the first subfile.

In a second manner, when one or more first files require subfile writing, the file reading and writing module is configured to, for each of the first files, first locate a sub-inode 22 of one of the first subfiles of the first file through the double-layer index structure 2 of this first file, then locate a data block 23 storing date of the first subfile, and finally load the data in the data block 23 into the dynamic random access memory, so as to perform a writing operation on the first subfile.

In a third manner, when one first file has first subfiles that need to be read as well as first subfiles where writing operations are needed, the file reading and writing module is configured to, locate a sub-inode 22 of one of the first subfiles that need to be read and a sub-inode 22 of one of the first subfiles where writing operations are needed through the double-layer index structure of this first file, so that the file reading and writing module can further locate a first data block for storing first data of the first subfile to be read and a second data block for storing second data of the first subfile to be written, and load both the first data in the first data block and the second data in the second data block into the dynamic random access memory, so as to perform a reading operation on the first subfile that needs to be read and perform a writing operation on the first subfile where writing operations are needed.

In some embodiments of the present disclosure, for each subfile, its sub-inode includes a first pointer pair, which is configured for managing log entries associated with file attribute changes. Specifically, after the writing operation on the subfile is completed, the file attribute of the subfile changes, and the fine-grained file system may update data associated with the file attribute changes through the first pointer pair. The file attribute includes a file size, creation time, file permission information, creator, and the like.

In some embodiments of the present disclosure, as shown in FIG. 3, each inode includes a key-value mapping table. The key-value mapping table includes one or more subfile numbers and one or more sub-inodes 22, with each of the subfile numbers corresponding one-to-one with one of the sub-inodes 22. The fine-grained file system obtains, based on subfile numbers of the first subfiles, sub-inodes that respectively correspond to the subfile numbers of the first subfiles.

Specifically, the data of each file is stored in one or more data blocks, and each of the data blocks corresponds to one subfile number and one sub-inode 22. When one or more first files require subfile reading or writing, the file reading and writing module is configured to, based on the key-value mapping table, first obtain a sub-inode 22 corresponding to a subfile number of a first subfile, and then locate a corresponding data block through the sub-inode 22.

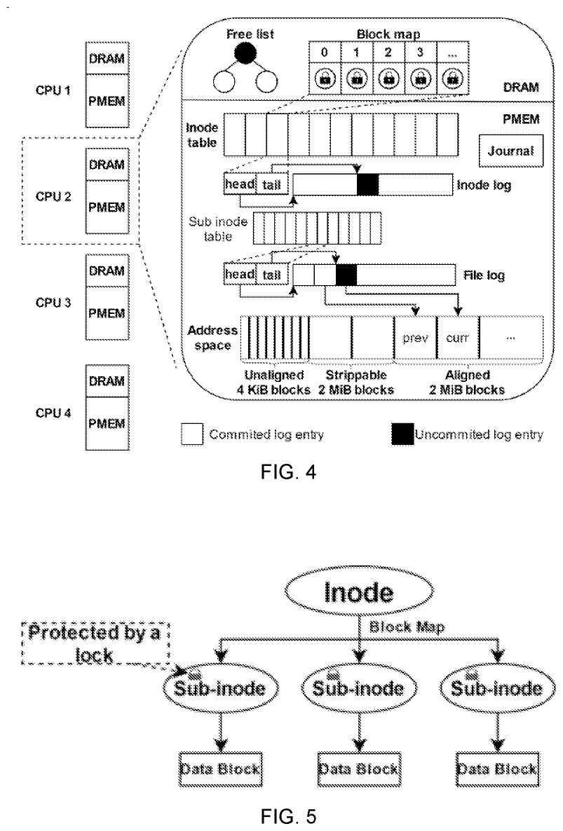

In some embodiments of the present disclosure, as shown in FIG. 4, for each subfile, its sub-inode includes a first pointer pair (head & tail). The first pointer pair is configured to determine a location of a file log of the subfile, so as to update file log information after a writing operation on the subfile is completed. The file log information includes an amount of written data through the present writing operation and a logical address of the written data in the storage device. The logical address is used by program codes and is generated by the operating system. The logical address is a segment of address space pointing to the memory, and is an offset relative to a start address of the program. That is, the logical address is used in the program. There is a correspondence between logical addresses and physical addresses, and the physical address of the written data in the storage device can be located through the logical address.

In some embodiments of the present disclosure, as shown in FIG. 4, the file log includes a second pointer pair consisting of a previous pointer and a current pointer. The second pointer pair is configured to obtain a physical address of the subfile when undergoing a reading or writing operation, and update the physical address. The second pointer pair is further configured to collect a file garbage after the physical address is updated.

Specifically, the data in the files is stored in a data area of a disk, the data area of the disk includes a plurality of data blocks, and the disk allocates a physical address for each data block. Each physical address is a real address in the memory and is generated by a CPU to access a data block.

The obtaining of the physical addresses of the subfiles includes: when one or more first files require subfile reading or writing, the second pointer pair first locates a physical address of a data block corresponding to each first subfile that requires reading or writing, then locates the data block through the physical address of the data block, and finally performs a reading or writing operation on the data block.

The updating of the physical addresses of the subfiles includes the previous pointer is used to locate a physical address of a data block for storing current data, and the current pointer is used to locate a physical address of a data block for storing updated data. Specifically, when one or more first files require subfile writing, the written data is stored in a corresponding data block through the current pointer, and after the writing operation is completed, the previous pointer points to a physical address of the corresponding data block of the current pointer, and the current pointer points to a physical address of a new data block that stores no data.

It should be noted that, when the previous pointer points to the physical address of the corresponding data block of the current pointer and the current pointer points to the physical address of the new data block, an update of the physical address of the first subfile is completed, that is, an update of the data version is completed.

After the physical address of each first subfile (i.e., subfiles where writing operations are needed) is updated, a data garbage (or, a file garbage) is stored in the disk. In order to release the disk space, garbage collection needs to be performed periodically. The garbage collection includes: when a first update of the physical address of the first subfile has been completed, the data in the data block corresponding to the physical address pointed by the previous pointer is stored in the disk as file garbage, and when a second update of the physical address of the first subfile has been completed, the data stored in the disk after the first update is recovered.

An example will now be given to illustrate that a completed update of the physical address of the first subfile is equivalent to an update of the data version. Assume that a first subfile currently read by a user is a first version of the first subfile, at this time, the previous pointer points to a physical address of a data block corresponding to the first version of the first subfile. The first version of the first subfile is a current version, and a zeroth version of the first subfile is the version immediately prior to the first version of the first subfile. When the user performs a writing operation on the first version of the first subfile, a system stores written data into the corresponding data block through the current pointer, and after the writing operation is completed, the previous pointer points to a physical address of the corresponding data block of the current pointer, and the current pointer points to a physical address of a new data block that stores no data, at which time, the previous pointer points to the physical address of the corresponding data block that corresponds to a second version of the first subfile. The second version of the first subfile is a current version, and the first version of the first subfile is the version immediately prior to the second version of the first subfile. The data stored in the data block corresponding to the initial version of the first subfile is recovered.

In some embodiments of the present disclosure, as shown in FIG. 5, each sub-inode includes a lock. The lock is configured to lock the subfile when a reading operation is performed on the subfile, and unlock the subfile when the reading operation is completed.

Specifically, when one or more first files require subfile reading, sub-inodes corresponding to subfiles where writing operations are needed are locked through their respective locks. At this time, other operations, such as reading operations, cannot be performed on the subfiles where writing operations are needed, and only the current writing operation can be performed. After the writing operation is completed, the locked sub-inodes become unlocked, and at this time, writing or reading operations can be performed on the subfiles.

In some embodiments of the present disclosure, when one first file has both first subfiles that need to be read and first subfiles where writing operations are needed, sub-inodes corresponding to the first subfiles where writing operations are needed are locked through their respective locks, in this case, the first subfiles where writing operations are needed cannot be read, but other unlocked first subfiles can be read. Since each sub-inode is protected by a lock, multiple users can read and write to the same file simultaneously. This resolves the issue where existing file systems force other users to wait until the current user completes their writing operation before performing any actions on the file, which reduces user waiting time and improves overall efficiency.

In some embodiments of the present disclosure, as shown in FIG. 4, the fine-grained file system further includes a free list associated with a plurality of data blocks for file management. The fine-grained file system creates a new file when the plurality of data blocks managed by the free list are not fully utilized.

Specifically, as shown in FIG. 4, some areas in the disk are allocated to the free list for file management. When the plurality of data blocks managed by the free list are not fully utilized, there are also unused data blocks in the disk for storing data, and at this time, the user may create a new file in the system. When all data blocks managed by the free list are utilized, there are no unused data blocks in the disk, at which time, the user may not create a new file in the system.

In some embodiments of the present disclosure, the updated information of the double-layer index structure is transmitted to the non-volatile memory device after the writing operation is completed. The updated information includes information such as file attribute change information and file log information. The file attribute includes a file size, creation time, file permission information, creator, and the like. The file log information includes an amount of written data through the present writing operation and a logical address of the written data in the storage device.

In some embodiments of the present disclosure, the fine-grained file system can be added to the file system section of a Linux kernel source tree. The fine-grained file system can be compiled into the kernel or loaded as a kernel module. Specifically, the fine-grained file system and the non-volatile memory device using the fine-grained file system are mounted to a corresponding mounting point through a mounting command in Linux.

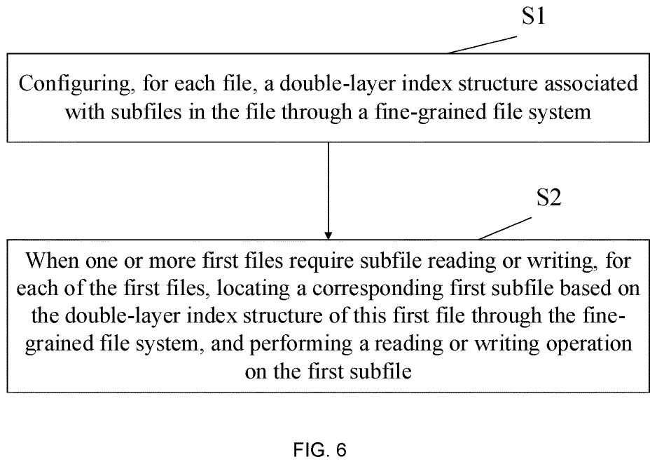

FIG. 6 shows a flowchart of a file reading and writing method according to an embodiment of disclosure present disclosure.

The file reading and writing method includes the following steps.

Step 1: configuring, for each file, a double-layer index structure associated with subfiles in the file through a fine-grained file system.

Step 2: when one or more first files require subfile reading or writing, for each of the first files, locating a corresponding first subfile based on the double-layer index structure of this first file through the fine-grained file system, and performing a reading or writing operation on the first subfile.

In some embodiments of the present disclosure, step 1 includes: dividing each file into a plurality of subfiles based on a preset allocation granularity, setting a double-layer index structure corresponding to this file, and constructing a mapping relationship between this file and its subfiles through the double-layer index structure. It should be noted that the preset allocation granularity may be in the size of any byte, which is not limited in the present disclosure.

In some preferred embodiments of the present disclosure, the preset allocation granularity may be set according to the size of the kernel page of the Linux operating system, that is, the preset allocation granularity is set as 4 KiB or 2 MiB. Each file is divided into a plurality of subfiles, and data blocks with 2 MiB allocation granularity are preferentially used to store subfile data, solving the problem of space fragmentation of the storage device.

In some embodiments of the present disclosure, step S2 includes the following manners.

In a first manner, when one or more first files require subfile reading, the file reading and writing module is configured to, for each of the first files, locate a data block corresponding to one of the first subfiles of the first file through the double-layer index structure of this first file, and load data in the data block into the dynamic random access memory, so as to perform a reading operation on the first subfile.

In a second manner, when one or more first files require subfile writing, the file reading and writing module is configured to, for each of the first files, locate a data block corresponding to one of the first subfiles of the first file through the double-layer index structure of this first file, and load data in the data block into the dynamic random access memory, so as to perform a writing operation on the first subfile.

In a third manner, when one first file has first subfiles that need to be read as well as first subfiles where writing operations are needed, the file reading and writing module is configured to, locate a first data block corresponding to one of the first subfiles that need to be read and a second data block corresponding to one of the first subfiles where writing operations are needed through the double-layer index structure of this first file, and load both a first data in the first data block and a second data in the second data block into the dynamic random access memory, so as to perform a reading operation on the first subfile that needs to be read and perform a writing operation on the first subfile where writing operations are needed.

In some embodiments of the present disclosure, the double-layer index structure of each file is configured by: establishing a first mapping relationship between an inode constructed for this file and sub-inodes respectively constructed for the subfiles in the file, so as to obtain a first layer index structure; establishing a second mapping relationship between the sub-inodes mapped to the inode and data blocks storing the subfiles corresponding to the sub-inodes, so as to obtain a second layer index structure; combining the first layer index structure and the second layer index structure to obtain the double-layer index structure.

In some embodiments of the present disclosure, the reading or writing operation includes the following manners.

In a first manner, when one or more first files require subfile reading, the file reading and writing module is configured to, for each of the first files, first locate a sub-inode of one of the first subfiles of the first file through the double-layer index structure of this first file, then locate a data block storing date of the first subfile, and finally load the data in the data block into the dynamic random access memory, so as to perform a reading operation on the first subfile.

In a second manner, when one or more first files require subfile writing, the file reading and writing module is configured to, for each of the first files, first locate a sub-inode of one of the first subfiles of the first file through the double-layer index structure of this first file, then locate a data block storing date of the first subfile, and finally load the data in the data block into the dynamic random access memory, so as to perform a writing operation on the first subfile.

In a third manner, when one first file has first subfiles that need to be read as well as first subfiles where writing operations are needed, the file reading and writing module is configured to, locate a sub-inode of one of the first subfiles that need to be read and a sub-inode of one of the first subfiles where writing operations are needed through the double-layer index structure of this first file, so that the file reading and writing module can further locate a first data block for storing first data of the first subfile to be read and a second data block for storing second data of the first subfile to be written, and load both the first data in the first data block and the second data in the second data block into the dynamic random access memory, so as to perform a reading operation on the first subfile that needs to be read and perform a writing operation on the first subfile where writing operations are needed.

In summary, the fine-grained file system and the file reading and writing method are disclosed herein. When one or more first files require subfile reading or writing, a corresponding reading or writing operation is performed on subfiles of each first file by utilizing a double-layer index structure of this first file, implementing concurrent reading and writing functionality for large individual files, resulting in faster speeds and improved efficiency for file reading and writing. Therefore, the present disclosure effectively overcomes various drawbacks of the prior art and has high industrial utilization value.

The above-mentioned embodiments only exemplarily illustrate the principles and effects of the present disclosure, but are not used to limit the present disclosure. Modifications or variations of the above-described embodiments may be made by those skilled in the art without departing from the spirit and scope of the present disclosure. Therefore, all equivalent modifications or changes made by those who have common knowledge in the art without departing from the spirit and technical concept disclosed by the present disclosure shall be still covered by the claims of the present disclosure.

1. A fine-grained file system, including:
an index structure setting module, configured to set, for each file, a double-layer index structure associated with subfiles in the file, and store the double-layer index structure in both a non-volatile memory device and a dynamic random access memory; and
a file reading and writing module, connected to the index structure setting module, wherein when one or more first files require subfile reading or writing, the file reading and writing module is configured to, for each of the first files, locate a corresponding first subfile based on the double-layer index structure of this first file, and load data in a data block storing the first subfile into the dynamic random access memory, so as to perform a reading or writing operation on the first subfile.

2. The fine-grained file system according to claim 1, wherein the double-layer index structure of each file is configured by:
establishing a first mapping relationship between an inode constructed for this file and sub-inodes respectively constructed for the subfiles in the file, so as to obtain a first layer index structure;
establishing a second mapping relationship between the sub-inodes mapped to the inode and data blocks storing the subfiles corresponding to the sub-inodes, so as to obtain a second layer index structure;
combining the first layer index structure and the second layer index structure to obtain the double-layer index structure.

3. The fine-grained file system according to claim 2, wherein the inode includes a key-value mapping table; wherein
the key-value mapping table includes one or more subfile numbers and one or more sub-inodes, with each of the subfile numbers corresponding one-to-one with one of the sub-inodes; the fine-grained file system obtains, based on subfile numbers of the first subfiles, sub-inodes that respectively correspond to the subfile numbers of the first subfiles according to the key-value mapping table.

4. The fine-grained file system according to claim 3, wherein for each subfile, its sub-inode includes a first pointer pair;
wherein the first pointer pair is configured to determine a location of a file log of the subfile, so as to update information of the file log after a writing operation on the subfile is completed.

5. The fine-grained file system according to claim 4, wherein the file log includes a second pointer pair; wherein
the second pointer pair is configured to obtain a physical address of the subfile when undergoing a reading or writing operation, and update the physical address; the second pointer pair is further configured to collect a file garbage after the physical address is updated.

6. The fine-grained file system according to claim 5, wherein the sub-inode includes a lock;
wherein the lock is configured to lock the subfile when a reading operation is performed on the subfile, and unlock the subfile when the reading operation is completed.

7. The fine-grained file system according to claim 5, further including a free list associated with a plurality of data blocks for file management;
wherein the fine-grained file system creates a new file when the plurality of data blocks managed by the free list are not fully utilized.

8. A file reading and writing method, including:
configuring, for each file, a double-layer index structure associated with subfiles in the file through a fine-grained file system;
when one or more first files require subfile reading or writing, for each of the first files, locating a corresponding first subfile based on the double-layer index structure of this first file through the fine-grained file system, and performing a reading or writing operation on the first subfile.
